(19) United States
(12) Patent Application Publication
(10) Pub. No.: US 2024/0270599 A1
(43) Pub. Date: Aug. 15, 2024

(54) LITHIUM NICKEL-BASED COMPOSITE OXIDE AS A POSITIVE ELECTRODE ACTIVE MATERIAL FOR SOLID-STATE LITHIUM-ION RECHARGEABLE BATTERIES

(71) Applicant: UMICORE, Brussels (BE)

(72) Inventors: JiHoon KANG, Chungcheongnam-do (KR); GyeongSeo PARK, Chungcheongnam-do (KR); Jens PAULSEN, Dunedin (NZ); Shinichi KUMAKURA, Olen (BE)

(21) Appl. No.: 18/562,315

(22) PCT Filed: May 25, 2022
(86) PCT No.: PCT/EP2022/064162

§ 371 Date: Nov. 19, 2023

Related U.S. Application Data
(60) Provisional application No. 63/193,759, filed on May 27, 2021.

(30) Foreign Application Priority Data
May 28, 2021 (EP) 21176445.1

(51) Int. Cl. C01G 53/00; H01M 4/02; H01M 4/13915; H01M 10/0525; H01M 10/0565

(52) U.S. Cl. CPC C01G 53/006; H01M 4/13915; H01M 10/0525; H01M 10/0565; C01P 2002/85; C01P 2004/03; C01P 2006/40; C01P 2006/80; H01M 2004/028; H01M 2300/0082

(57) ABSTRACT

The present invention relates to a lithium nickel-based composite oxide as a positive electrode active material for lithium-ion rechargeable batteries suitable for electric vehicle and hybrid electric vehicle applications, comprising lithium nickel-based oxide particles comprising tungsten.

### TECHNICAL FIELD AND BACKGROUND

The present invention relates to a lithium nickel-based composite oxide as a positive electrode active material for lithium-ion rechargeable batteries suitable for electric vehicle (EV) and hybrid electric vehicle (HEV) applications, comprising lithium nickel-based oxide particles comprising tungsten (W).

A positive electrode active material is defined as a material which is electrochemically active in a positive electrode. By active material, it must be understood a material capable to capture and release Li ions when subjected to a voltage change over a predetermined period of time.

In the framework of the present invention, at % signifies atomic percentage. The at % or “atomic percent” of a given element expression of a concentration means how many percent of all atoms in the concerned compound are atoms of said element. The designation at % is equivalent to mol %.

The use of W coated positive electrode material for solid-state rechargeable batteries was studied by Lim, C. B. and Park, Y. J. in Sci Rep 10, 10501 (2020).

However, this positive electrode active material comprising W has a high leaked capacity (Qₜₒₜₐₗ) when applied in a solid-state battery.

It is an object of the present invention to provide a positive electrode active material having an improved Qₜₒₜₐₗ in a solid-state battery, preferably in a solid-state lithium-ion rechargeable battery obtained by the methods of the present invention.

### SUMMARY OF THE INVENTION

This objective is achieved by providing a positive electrode active material for solid-state batteries, wherein the positive electrode active material comprises Li, M′, and oxygen, wherein M′ comprises:
Ni in a content x between 50.0 mol % and 95.0 mol %, relative to M′;
Co in a content y between 0.0 mol % and 40.0 mol %, relative to M′;
Mn in a content z between 0.0 mol % and 70.0 mol %, preferably between 0.0 mol % and 40.0 mol %, relative to M′;
W in a content w between 0.05 mol % and 2.0 mol %
Al in a content v between 0.1 mol % and 3.0 mol %,
F in a content f lower than 2.0 mol %,
Q in a content q less than 3.0 mol %, relative to the total atomic content of M′, wherein Q comprises and at least one element of the group consisting of: B, Ba, Ca, Cr, Fe, Mg, Mo, Nb, S, Si, Sr, Ti, Y, V, and Zr,
wherein x, y, z, v, w and q are measured by ICP and wherein f is measured by IC,
wherein (x+y+z+v+w+f+q)=100.0 mol %,
   wherein the positive electrode active material has ratios Al_{B}/v>25.0, preferably >50.0 and W_{B}/W>5.0, preferably >10.0,
   wherein Al_{B} and W_{B} are determined by XPS analysis, wherein Al_{B} and W_{B} are expressed as mol % compared to the sum of Ni, Co, Mn, Al, W, and F as measured by XPS analysis. Such a material has improved electrochemical characteristics, in particular a much reduced capacity leakage at higher temperature.

Preferably, Al_{B}/v>60.0 and more preferably Al_{B}/v>70.0.

Preferably, Al_{B}/v<250.0 and more preferably Al_{B}/v<200.0.

In certain preferred embodiments Alb/v is between 60 and 250, preferably between 70 and 200, more preferably between 80 and 135.

Preferably, W_{B}/w>21.0 and more preferably W_{B}/w>22.0.

Preferably, W_{B}/W<150.0 and more preferably W_{B}/W<100.0.

In certain preferred embodiments Wb/w is between 21.0 and 150.0, preferably between 22.0 and 100.0, more preferably between 30.0 and 50.0.

A certain preferred embodiment is the positive electrode active material of the invention, wherein Ni in a content x between 55.0 mol %≤x≤75.0 mol %, preferably 60.0 mol %≤x≤70.0 mol %, more preferably 62.0 mol %≤x≤68.0 mol %, relative to M′.

A certain preferred embodiment is the positive electrode active material of the invention, wherein Ni in a content x between 75.0 mol %≤x≤95.0 mol %, preferably 80.0 mol %≤x≤90.0 mol %, more preferably 80.0 mol %≤x≤85.0 mol %, relative to M′.

As appreciated by the skilled person the amount of Li and M′, preferably Li, Ni, Mn, Co, W, Al and Q in the positive electrode active material is measured with Inductively Coupled Plasma (ICP). For example, but not limiting to the invention, an Agilent ICP 720-ES is used in the ICP analysis. In the framework of the present invention, “atomic content” or “at %” of a given element expression of a concentration means how many percent of all atoms in the concerned compound are atoms of said element. The designation mol % is equivalent to “molar percent” or “at %”.

In a preferred embodiment Mn is in a content z between 0.0 mol %<z≤40.0 mol %, preferably 3.0 mol %≤z≤20.0 mol %, more preferably 5.0 mol %≤z≤10.0 mol %.

In a preferred embodiment Co is in a content y between 0.0 mol %<z≤40.0 mol %, preferably 3.0 mol %≤z≤20.0 mol %, more preferably 5.0 mol %≤z≤10.0 mol %, relative to M′.

In a preferred embodiment W is in a content w between 0.05 mol % and 2.0 mol % relative to M′, preferably between 0.1 mol % and 1.0 mol %, more preferably between 0.2 mol % and 0.5 mol %, relative to M′.

In a preferred embodiment Al is in a content v between 0.1 mol % and 3.0 mol %, relative to M′, preferably between 0.2 mol % and 1.5 mol %, more preferably between 0.3 mol % and 0.5 mol %, relative M′.

In a preferred embodiment F is in a content f lower than 2.0 mol %, relative to M′, preferably lower than 1.5 mol %, more preferably lower than 1.2 mol %, relative to M′. In a preferred embodiment F in a content f higher than 0.0 mol %, relative to M′, preferably higher than 0.5 mol %, more preferably higher than 0.8 mol %, relative to M′. In certain preferred embodiment f=0.0 mol % relative to M′. As appreciated by the skilled person the amount of f is determined with Ion Chromatography (IC) analysis. For example, but not limiting to the invention, a Dionex ICS-2100 (Thermo scientific) is used in the IC analysis.

In a preferred embodiment Q is in a content q less than 3.0 mol %, relative to the total atomic content of M′. In a preferred embodiment Q is in a content q less than 2.0 mol %, relative to M′, preferably less than 1.0 mol %. In a preferred embodiment Q is in a content q more than 0.0 mol %, relative to the total atomic content of M′. In a preferred embodiment Q is in a content q more than 0.5 mol %, relative to M′, preferably more than 0.8 mol %, relative to M′. In certain preferred embodiment Q is in a content q=0.0 mol %, relative to M′.

In a preferred embodiment f>0, wherein the positive electrode active material has ratio F_{B}/f>10.0, preferably >12.0, more preferably >14.0. wherein F_{B} is determined by XPS analysis, wherein FB is expressed as mol % compared to the sum of Ni, Co, Mn, Al, W, and F, as measured by XPS analysis. In a preferred embodiment f>0, wherein the positive electrode active material has ratio F_{B}/f<30.0, preferably <20.0 , more preferably <17.0, wherein F_{B} is determined by XPS analysis, wherein F_{B} is expressed as mol % compared to the sum of Ni, Co, Mn, Al, W, and F, as measured by XPS analysis. In a preferred embodiment f>0, wherein the positive electrode active material has ratio F_{B}/f between 10.0 and 20, preferably between 12.0 and 17.0, more preferably between 14.0 and 16.0, wherein F_{B} is determined by XPS analysis, wherein F_{B} is expressed as mol % compared to the sum of Ni, Co, Mn, Al, W, and F, as measured by XPS analysis.

In particular, Al_{B}, W_{B} and F_{B} are the average molar fractions of Al, W, and F, respectively, measured in a region of a particle of the cathode material powder according to invention defined between a first point of an external edge of said particle and a second point at a distance from said fist point, said distance separating said first to said second point being equal to a penetration depth of said XPS, said penetration depth being comprised between 1.0 to 10.0 nm. In particular, the penetration depth is the distance along an axis perpendicular to a virtual line tangent to said external edge and passing trough said first point.

The external edge of the particle is, in the framework of this invention, the boundary or external limit distinguishing the particle from its external environment.

In a preferred embodiment, said positive electrode active material according to the first aspect comprises secondary particles comprising more than one primary particle.

In another preferred embodiment, said positive electrode active material according to the first aspect comprises single-crystalline particles.

In certain preferred embodiments a particle is considered to be single-crystalline if it consists of only one grain or at most five, preferably at most 3 three, constituent grains, as observed by SEM or TEM, preferably by observing grain boundaries.

In the context of the present invention a grain boundary is defined as the interface between two grains in a particle, preferably wherein the atomic planes of the two grains are aligned to different orientations and meet as a crystalline discontinuity.

As appreciated by the skilled person and in the context of the present invention, said positive electrode active material comprises single-crystalline particles-in which 80% or more of the particles in a field of view of at least 45 μm×at least 60 μm (i.e. of at least 2700 μm²), preferably of: at least 100 μm×100 μm (i.e. of at least 10,000 μm²) in a SEM image are single-crystalline.

For the determination of single-crystalline particles, grains which have a largest linear dimension as observed by SEM which is smaller than 20% of the median particle size D50 of the particle as determined by laser diffraction are ignored. This avoids that particles which are in essence single-crystalline, but which may have deposited on them several very small other grains, are inadvertently considered as not being single-crystalline.

In certain preferred embodiments of the invention and in the context of the present invention the single-crystalline particle is a monolithic particle. As appreciated by the skilled person in these certain preferred embodiments all embodiments related to the single-crystalline particle equally apply to the monolithic particle.

In another preferred embodiment, said positive electrode active material according to the first aspect comprises poly-crystalline particles. As appreciated by the skilled person the poly-crystalline particles are agglomerated by 5 or more single-crystalline particles, preferably 10 or more single-crystalline particles, more preferably 50 or more single-crystalline particles. This can be observed in proper microscope techniques like Scanning Electron Microscope (SEM) by observing grain boundaries. Agglomeration of the single-crystalline particles to the poly-crystalline particles occurs under a post-treatment step such as a thermal treatment step.

In a preferred embodiment Q comprises at least one element of the group consisting of: B, Ba, Ca, Cr, Fe, Mg, Mo, Nb, S, Si, Sr, Ti, Y, V, and Zr, preferably Q is at least one element of the group consisting of: B, Ba, Ca, Cr, Fe, Mg, Mo, Nb, S, Si, Sr, Ti, Y, V, and Zr, more preferably, B, Cr, Nb, S, Si, Ti, Y and Zr, most preferably Zr.

The invention further concerns a positive electrode for lithium-ion rechargeable batteries, comprising a positive electrode active material according to the invention as defined above.

Preferably, this invention provides a polymer cell for lithium-ion rechargeable batteries, comprising a positive electrode active material according to the first embodiment.

The invention further concerns a polymer cell for lithium-ion rechargeable batteries, the polymer cell comprising a positive electrode active material according to the invention as defined above.

The invention further concerns a lithium-ion rechargeable battery comprising a positive electrode active material according to the invention as defined above.

The invention further concerns a method for manufacturing a positive electrode active material for solid-state batteries, comprising the consecutive steps of
preparing a lithium transition metal-based oxide compound,
mixing said lithium transition metal-based oxide compound with sources of Al and W, thereby obtaining a mixture, and
heating the mixture in an oxidizing atmosphere in a furnace at a temperature between 250° C. and less than 500° C., preferably at most 450° C., for a time between 1 hour and 20 hours so as to obtain said the positive electrode active material powder.

In a preferred embodiment of the method the lithium transition metal-based oxide compound comprises Li, M′ and oxygen, wherein M′ comprises Ni, Mn, Co and Q.

Preferably the lithium transition metal oxide compound used is also typically prepared according to a lithiation process, that is the process wherein a mixture of a transition metal precursor and a lithium source is heated at a temperature preferably of at least 500° C. Typically, the transition metal precursor is prepared by coprecipitation of one or more transition metal sources, such as salts, and preferably sulfates of the M′ elements Ni, Mn and/or Co, in the presence of an alkali compound, such as an alkali hydroxide e.g. sodium hydroxide and/or ammonia.

Preferably said mixing said lithium transition metal-based oxide compound with an additional source of F obtaining the mixture,

Preferably said positive electrode active material is a positive electrode active material according to the invention as defined above.

As appreciated by the skilled person the ratio of Al_{B}/v can for example be increased or decreased by mixing respectively higher or lower amounts of the source of Al with the lithium transition metal-based oxide compound.

As appreciated by the skilled person the ratio of W_{B}/w can for example be increased or decreased by mixing respectively higher or lower amounts of the source of W with the lithium transition metal-based oxide compound.

As appreciated by the skilled person the ratio of F_{B}/f can for example be increased or decreased by mixing respectively higher or lower amounts of the source of F with the lithium transition metal-based oxide compound.

The invention further concerns a method for manufacturing a polymer cell for solid-state lithium-ion rechargeable battery, wherein said method comprises the steps of:
a step of preparing a solid polymer electrolyte film by mixing a first polyethylene oxide having a molecular weight of less than 1,500,000 g/mol and more than 500,000 g/mol with a lithium salt in a nonaqueous solvent;
a step of preparing a positive electrode by mixing a second polyethylene oxide, a lithium salt, a positive electrode active material, and a conductor powder in a nonaqueous solvent, wherein the second polyethylene oxide has a molecular weight of less than 300,000 and more than 50,000 g/mol;
a step of preparing a negative electrode comprising a lithium metal; and
a step of assembling the solid polymer electrolyte film, the positive electrode and the negative electrode to form a polymer cell for a solid-state rechargeable battery.

Preferably, the positive electrode active material is a positive electrode active material according to the invention as defined above.

Polymer cells manufactured according to the invention are particularly suitable for reliable testing of electrochemical properties.

### BRIEF DESCRIPTION OF THE FIGURES

As further guidance, figures are included to better appreciate the teaching of the present invention. Said figures are intended to assist the description of the invention and are nowhere intended as a limitation of the presently disclosed invention. The figures and symbols contained therein have the meaning as commonly understood by one of ordinary skill in the art to which this invention belongs.

FIG. 1 shows a Scanning Electron Microscope (SEM) image of a positive electrode active material powder according to EX1 with polycrystalline morphology.

FIG. 2 shows a SEM image of a positive electrode active material powder to EX2 with single-crystalline morphology.

FIG. 3 shows an X-ray photoelectron spectroscopy (XPS) graphs showing the presence of Al2p peak and W4f peaks in EX1 in comparison with CEX1 and CEX2.

### DETAILED DESCRIPTION

In the drawings and the following detailed description, preferred embodiments are described so as to enable the practice of the invention. Although the invention is described with reference to these specific preferred embodiments, the invention includes numerous alternatives, modifications and equivalents that are apparent from consideration of the following detailed description and accompanying drawings.

### A) Inductively Coupled Plasma (ICP) Analysis

The amount of Li, Ni, Mn, Co, Al, B, Ba, Ca, Cr, Fe, Mg, Mo, Nb, S, Si, Sr, Ti, Y, V, W and Zr in the positive electrode active material powder is measured with the Inductively Coupled Plasma (ICP) method by using an Agillent ICP 720-ES (Agilent Technologies, https://www.agilent.com/cs/library/brochures/5990-6497EN %20720-725_ICP-OES_LR.pdf). 2 grams of powder sample is dissolved into 10 mL of high purity hydrochloric acid (at least 37 wt % of HCl with respect to the total weight of solution) in an Erlenmeyer flask. The flask is covered by a glass and heated on a hot plate at 380° C. until complete dissolution of the precursor. After being cooled to room temperature, the solution of the Erlenmeyer flask is poured into a 250 mL volumetric flask. Afterwards, the volumetric flask is filled with deionized water up to the 250 mL mark, followed by complete homogenization. An appropriate amount of solution is taken out by pipette and transferred into a 250 mL volumetric flask for the 2nd dilution, where the volumetric flask is filled with internal standard and 10% hydrochloric acid up to the 250 mL mark and then homogenized. Finally, this 50 mL solution is used for ICP measurement.

### B) Ion Chromatography (IC) Analysis

The amount of F in the positive electrode active material powder is measured with the Ion Chromatography (IC) method by using a Dionex ICS-2100 (Thermo scientific). 250 mL volumetric flask and 100 mL volumetric flask are rinsed with a mixed solution of 65 wt % HNO₃ and deionized water in a volumetric ratio of 1:1 right before use, then, the flasks are rinsed with deionized water at least 5 times. 2 mL of HNO₃, 2 mL of H₂O₂, and 2 mL of deionized water are mixed as a solvent. 0.5 grams of powder sample is dissolved into the mixed solvent. The solution is completely transferred from the vessel into a 250 ml volumetric flask and the flask is filled with deionized water up to 250 mL mark. The filled flask is shaken well to ensure the homogeneity of the solution. 9 mL of the solution from the 250 mL flask is transferred to a 100 mL volumetric flask. The 100 mL volumetric flask is filled with deionized water up to 100 mL mark and the diluted solution is shaken well to obtain a homogeneous sample solution. 2 mL of the sample solution is inserted into 5 mL IC vial via a syringe-onguard cartridge for IC measurement.

### C) Scanning Electron Microscope (SEM) Analysis

The morphology of positive electrode active materials is analyzed by a Scanning Electron Microscopy (SEM) technique. The measurement is performed with a JEOL JSM 7100F (https://www.jeolbenelux.com/JEOL-BV-News/jsm-7100f-thermal-field-emission-electron-microscope) under a high vacuum environment of 9.6×10−5 Pa at 25° C.

### D) X-ray photoelectron spectroscopy (XPS) Analysis

In the present invention, X-ray photoelectron spectroscopy (XPS) is used to analyze the surface of positive electrode active material powder particles. In XPS measurement, the signal is acquired from the first few nanometers (e.g. 1 nm to 10 nm) of the uppermost part of a sample, i.e. surface layer. Therefore, all elements measured by XPS are contained in the surface layer.

For the surface analysis of positive electrode active material powder particles, XPS measurement is carried out using a Thermo K-α+ spectrometer (Thermo Scientific, https://www.thermofisher.com/order/catalog/product/IQLAADGAAFFACVMAHV). Monochromatic Al Kα radiation (hv=1486.6 eV) is used with a spot size of 400 μm and measurement angle of 45°. A wide survey scan to identify elements present at the surface is conducted at 200 eV pass energy. C1s peak having a maximum intensity (or centered) at a binding energy of 284.8 eV is used as a calibrate peak position after data collection. Accurate narrow scans are performed afterwards at 50 eV for at least 10 scans for each identified element to determine the precise surface composition.

Curve fitting is done with CasaXPS Version 2.3.19PR1.0 (Casa Software, http://www.casaxps.com/) using a Shirley-type background treatment and Scofield sensitivity factors. The fitting parameters are according to Table 1a. Line shape GL(30) is the Gaussian/Lorentzian product formula with 70% Gaussian line and 30% Lorentzian line. LA(α, β, m) is an asymmetric line-shape where a and B define tail spreading of the peak and m define the width.

TABLE 1a
XPS fitting parameter for Ni2p3, Mn2p3, Co2p3, Al2p, W4f, and F1s.

| | Sensitivity | Fitting range | | |
|---|---|---|---|---|
| Element | factor | (eV) | Defined peak(s) | Line shape |
| Ni | 14.61 | 851.3 ± 0.1- | Ni2p3, Ni2p3 satellite | LA(1.33, 2.44, 69) |
| | | 869.4 ± 0.1 | | |
| Mn | 9.17 | 639.9 ± 0.1- | Mn2p3, Mn2p3 satellite | GL(30) |
| | | 649.5 ± 0.1 | | |
| Co | 12.62 | 775.8 ± 0.4- | Co2p3-1, Co2p3-2, Co2p3 | GL(30) |
| | | 792.5 ± 0.4 | satellite | |
| Al | 0.54 | 64.1 ± 0.1- | Al2p, Ni3p1, Ni3p3, Ni3p1 | GL(30) |
| | | 78.5 ± 0.1 | satellite, Ni3p3 satellite | |
| W | 9.80 | 29.0-45.0 | W4f7, W4f5, W4f loss | GL(30) |
| F | 4.43 | 682.0 ± 0.1- | F1s | LA(1.53, 243, 1) |
| | | 688.0 ± 0.1 | | |

For Al peak in the fitting range of 64.1±0.1 eV to 78.5±0.1 eV, constraints are set for each defined peak according to Table 1b. Ni3p peaks are not included in the quantification.

TABLE 1b
XPS fitting constraints for Al2p peak fitting.

| Peak | Fitting range (eV) | FWHM (eV) | Area |
|---|---|---|---|
| Al2p | 72.0-78.5 | 0.5-3.0 | No constraint set |
| Ni3p1 | 68.0-70.5 | 0.5-2.9 | 50% of Ni3p3 area |
| Ni3p3 | 65.3-68.0 | 0.5-2.9 | No constraint set |
| Ni3p1 satellite | 72.5-75.0 | 0.5-2.9 | 20% of Ni3p3 area |
| Ni3p3 satellite | 70.5-72.5 | 0.5-2.9 | 40% of Ni3p3 area |

The Al, W, and F surface contents as determined by XPS are expressed as a molar percentage of Al, W, and F in the surface of the particles divided by the total content of Ni, Mn, Co, Al, W, and F in said surface. They are calculated as follows:

$$\begin{matrix}A {l}_{B} = ( mol \% ) 100 \times \frac{A l}{N i + M n + C o + A l + W + F} \\ {W}_{B} = ( mol \% ) 100 \times \frac{W}{N i + M n + C o + A l + W + F} \\ {F}_{B} = ( mol \% ) 100 \times \frac{F}{N i + M n + C o + A l + W + F}\end{matrix}$$

### E) Polymer Solid-State Test

E1) Polymer solid-state battery preparation

### E1-1) Solid Polymer Electrolyte (SPE) Preparation

Solid polymer electrolyte (SPE) is prepared according to the process as follows:
Step 1) Mixing polyethylene oxide (PEO, 1,000,000 g/mol, Alfa Aesar) with lithium bis(trifluoromethanesulfonyl)imide salt (LiTFSI, >98.0%, TCI) in acetonitrile anhydrous 99.8 wt. % (Aldrich), using a mixer for 30 minutes at 2000 revolutions per minute (rpm).
The mass ratio of polyethylene oxide to LiTFSI is 3.0.
Step 2) Pouring the mixture from Step1) into a Teflon dish and dried in 25° C. for 12 hours.
Step 3) Detaching the dried SPE from the dish and punching the dried SPE in order to obtain SPE disks having a thickness of 300 μm and a diameter of 19 mm.

### E1-2) Positive Electrode Preparation

Positive electrode is prepared according to the process as follows:
Step 1) Preparing a polymer electrolyte mixture comprising polyethylene oxide (PEO, 100,000 g/mol, Alfa Aesar) solution in anisole anhydrous 99.7 wt. % (Sigma-Aldrich) and Lithium bis(trifluoromethanesulfonyl)imide salt (LiTFSI, >98.0%, TCI) in acetonitrile. The mixture has a ratio of PEO:LiTFSI of 74:26 by weight.
Step 2) Mixing a polymer electrolyte mixture prepared from Step 1), a positive electrode active material, and a conductor powder (Super P, Timcal) in acetonitrile solution with a ratio of 21:75:4 by weight so as to prepare a slurry mixture. The mixing is performed by a homogenizer for 45 minutes at 5000 rpm.
Step 3) Casting the slurry mixture from Step 2) on one side of a 20 μm-thick aluminum foil with 100 μm coater gap.
Step 4) Drying the slurry-casted foil at 30° C. for 12 hours followed by punching in order to obtain catholyte electrodes having a diameter of 14 mm.

### E1-3) Negative Electrode Preparation

A Li foil (diameter 16 mm, thickness 500 μm) is prepared as a negative electrode.

### E1-3) Polymer Cell Assembling

The coin-type polymer cell is assembled in an argon-filled glovebox with an order from bottom to top: a 2032 coin cell can, a positive electrode prepared from section E1-2), a SPE prepared from section E1-1), a gasket, a negative electrode prepared from section E1-3), a spacer, a wave spring, and a cell cap. Then, the coin cell is completely sealed to prevent leakage of the electrolyte.

### E2) Testing Method

Each coin-type polymer cell is cycled at 80° C. using a Toscat-3100 computer-controlled galvanostatic cycling stations (from Toyo). The coin cell testing procedure uses a 1 C current definition of 160 mA/g in the 4.4-3.0 V/Li metal window range according to the schedule below:
Step 1) Charging in a constant current mode with C-rate of 0.05 with an end condition of 4.4 V followed by 10 minutes rest.
Step 2) Discharging in a constant current mode with C-rate of 0.05 with an end condition of 3.0 V followed by 10 minutes rest.
Step 3) Charging in a constant current mode with C-rate of 0.05 with an end condition of 4.4 V.
Step 4) Switching to a constant voltage mode and keeping 4.4 V for 60 hours.
Step 5) Discharging in a constant current mode with C-rate of 0.05 with an end condition of 3.0 V.

Qₜₒₜₐₗ is defined as the total leaked capacity at the high voltage and high temperature in the Step 4) according to the described testing method. A low value of Qₜₒₜₐₗ indicates a high stability of the positive electrode active material powder during a high temperature operation.

### EXAMPLE 1

A polycrystalline positive electrode active material EX1 is prepared according to the following process.
1) Co-precipitation: a transition metal-based oxidized hydroxide precursor with metal composition of Ni_{0.835}Mn_{0.080}Co0.085 is prepared by a co-precipitation process in a large-scale continuous stirred tank reactor (CSTR) with mixed-manganese-cobalt sulfates, sodium hydroxide, and ammonia.
2) First mixing: the transition metal-based oxidized hydroxide precursor and LiOH as a lithium source are homogeneously mixed with a lithium to metal M′ (Li/M′) ratio of 0.98 in an industrial blending equipment to obtain a first mixture wherein M′ is a total molar content of Ni, Mn and Co.
3) First heating: the first mixture from Step 2) is heated at 770° C. for 10 hours under an oxygen atmosphere. The heated powder is crushed, classified, and sieved so as to obtain a lithium transition metal composite oxide P1.
4) Second mixing: 60 grams of P1 is mixed with 0.12 grams of alumina (Al₂O₃) nano-powder and 0.34 grams of WO₃ to obtain a second mixture.
5) Second heating: The second mixture from Step 4) is heated at 350° C.for 6 hours under an oxygen atmosphere. The heated powder is labelled as EX1. The powder comprises secondary particles consisting of a plurality of primary particles.

### EXAMPLE 2

A single-crystalline positive electrode active material EX2 is prepared according to the following process.
1) Co-precipitation: a transition metal-based oxidized hydroxide precursor with metal composition of Ni_{0.850}Mn_{0.070}Co_{0.080} is prepared by a co-precipitation process in a large-scale continuous stirred tank reactor (CSTR) with mixed-manganese-cobalt sulfates, sodium hydroxide, and ammonia.
2) First mixing: the transition metal-based oxidized hydroxide precursor and LiOH as a lithium source are homogeneously mixed with a lithium to metal M′ (Li/M′) ratio of 0.99 in an industrial blending equipment to obtain a first mixture wherein M′ is a total molar content of Ni, Mn, and Co.
3) First heating: the first mixture from Step 2) is heated at 890° C. for 11 hours under an oxygen atmosphere. The heated powder is crushed and sieved so as to obtain a lithium transition metal composite oxide P2a.
4) Wet milling: 0.50 mol % CoSO₄ is added with respect to the total amount of Ni, Mn, and Co in P2a while P2a is milled in aqueous condition. After filtration of the solution, the slurry is dried at 175° C. for 15 hours under a dry air atmosphere so as to obtain P2b.
5) Second mixing: P2b is mixed homogeneously with ZrO₂, Co₃O₄, and LiOH in an industrial blending equipment to obtain a second mixture wherein the amounts of the ZrO₂ and Co304 are 0.25 mol % and 0.50 mol % with respect to the total amount of Ni, Mn, and Co in P2b, respectively, and a lithium to metal M′ (Li/M′) molar ratio of the second mixture is 0.99 wherein M′ is a total molar content of Ni, Mn, and Co in the second mixture.
6) Second heating: the second mixture from Step 5) is heated at 760° C.for 12 hours and 30 minutes under oxygen atmosphere. The heated powder is crushed and sieved so as to obtain a lithium transition metal composite oxide P2c.
7) Third mixing: 60 grams of P2c is mixed with 0.12 grams of alumina (Al₂O₃) nano-powder and 0.34 grams of WO₃ to obtain a third mixture.
8) Third heating: The third mixture from Step 7) is heated at 350° C. for 6 hours under an oxygen atmosphere. The heated powder is labelled as EX2. The powder comprises single-crystalline particles.

### EXAMPLE 3

60 grams of P1 from example 1, which is polycrystalline, is mixed with 0.12 grams of alumina (Al₂O₃) nano-powder, 0.34 grams of WO₃, and 0.18 grams of PVDF to obtain a mixture. The mixture is heated at 350° C. for 6 hours under an oxygen atmosphere. The heated powder is labelled as EX3.

### EXAMPLE 4

60 grams of P2c from example 2, which is single-crystalline, is mixed with 0.12 grams of alumina (Al₂O₃) nano-powder, 0.34 grams of WO₃, and 0.18 grams of PVDF to obtain a mixture. The mixture is heated at 350° C.for 6 hours under an oxygen atmosphere. The heated powder is labelled as EX4.

### Comparative Example 1

60 grams of P1 from example1 is mixed with 0.12 grams of alumina (Al₂O₃) nano-powder and 0.18 grams of PVDF to obtain a mixture. The mixture is heated at 375° C.for 7 hours under an oxygen atmosphere. The heated powder is labelled as CEX1.

### Comparative Example 2

60 grams of P1 from example 1 is mixed with 0.34 grams of WO₃ to obtain a mixture. The mixture is heated at 375° C. for 7 hours under an oxygen atmosphere. The heated powder is labelled as CEX2.

Table 2 summarizes the chemical composition, as measured by ICP for Ni, Mn, Co, Al, and W and as measured by IC for F, of the products of the various examples and comparative examples. As these products are free of any other dopants, the compositions in table 2 are equivalent to the parameters x, y, z, v, w, and f as defined in the claims.

TABLE 2

| | Ni | Mn | Co | Al | W | F |
|---|---|---|---|---|---|---|
| Example | (at %) | (at %) | (at %) | (at %) | (at %) | (at %) |
| ID | x | z | y | v | w | f |
| EX1 | 83.037 | 7.961 | 8.445 | 0.315 | 0.242 | 0.000 |
| EX2 | 83.744 | 6.789 | 8.810 | 0.430 | 0.227 | 0.000 |
| EX3 | 82.160 | 7.872 | 8.352 | 0.364 | 0.228 | 1.023 |
| EX4 | 82.815 | 6.760 | 8.720 | 0.446 | 0.227 | 1.032 |
| CEX1 | 82.304 | 7.919 | 8.390 | 0.371 | 0.000 | 1.017 |
| CEX2 | 83.301 | 7.995 | 8.476 | 0.000 | 0.229 | 0.000 |

Table 3 summarizes the chemical composition as measured by XPS for Ni, Mn, Co, Al, W, and F, of the products of the various examples and comparative examples. As these products are free of any other dopants, the compositions in table 3 are equivalent to the parameters Ni_{B}, Mn_{B}, CO_{B}, Al_{B}, W_{B}, and F_{B} as defined in the claims.

TABLE 3

| | Ni | Mn | Co | Al | W | F |
|---|---|---|---|---|---|---|
| Example | (at %) | (at %) | (at %) | (at %) | (at %) | (at %) |
| ID | Ni_{B} | Mn_{B} | Co_{B} | Al_{B} | W_{B} | F_{B} |
| EX1 | 35.530 | 10.390 | 4.870 | 41.310 | 7.750 | 0.150 |
| EX2 | 31.410 | 7.990 | 5.470 | 45.420 | 9.680 | 0.030 |
| EX3 | 32.590 | 8.910 | 3.760 | 34.070 | 5.530 | 15.140 |
| EX4 | 26.090 | 6.980 | 4.590 | 37.810 | 8.190 | 16.340 |
| CEX1 | 35.140 | 8.660 | 4.080 | 34.370 | 0.000 | 17.750 |
| CEX2 | 52.550 | 14.650 | 5.980 | 13.750 | 12.460 | 0.610 |

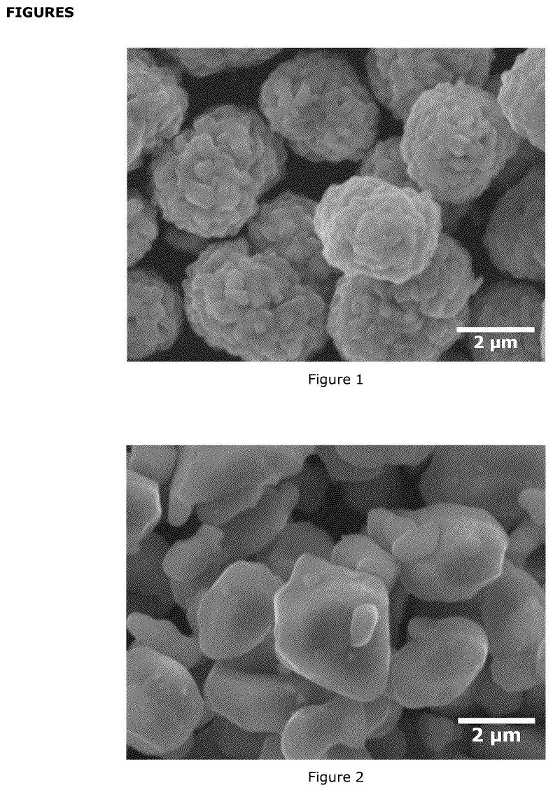

Table 4 summarizes the added amount of Al₂O₃, WO₃, and PVDF, ratios of molar fractions analyzed from XPS and ICP, and the corresponding Qₜₒₜₐₗ of examples and comparative examples. EX1, EX2, EX3 and EX4 contain both Al and W, while CEX1 contains Al and F and CEX2 only contains W. The positive electrode active material EX1 comprising a polycrystalline morphology is observed by SEM as FIG. 1 represented. FIG. 2 is a representative SEM image of the single-crystalline positive electrode active material EX2

TABLE 4
Summary of the added amount of Al₂O₃, WO₃, and PVDF, ratios
of molar fractions analyzed from XPS and ICP, and the corresponding
Qₜₒₜₐₗ of examples and comparative examples.

| | | | | | | | Qₜₒₜₐₗ in a |
|---|---|---|---|---|---|---|---|
| | | | | | | | polymer |
| Example | Added amount (wt %) | | | Al_{B}/ | W_{B}/ | F_{B}/ | cell |
| ID | Al₂O₃ | WO₃ | PVDF | v | w | f | (mAh/g) |
| EX1 | 0.20 | 0.56 | 0.00 | 131.14 | 32.02 | n/a* | 54.1 |
| EX2 | 0.20 | 0.56 | 0.00 | 105.63 | 42.64 | n/a | 38.9 |
| EX3 | 0.20 | 0.56 | 0.30 | 93.60 | 24.25 | 14.80 | 44.6 |
| EX4 | 0.20 | 0.56 | 0.30 | 84.78 | 36.08 | 15.83 | 32.5 |
| CEX1 | 0.20 | 0.00 | 0.30 | 92.64 | n/a | 17.45 | 95.4 |
| CEX2 | 0.00 | 0.56 | 0.00 | n/a | 54.41 | n/a | 73.1 |

*n/a = Not applicable

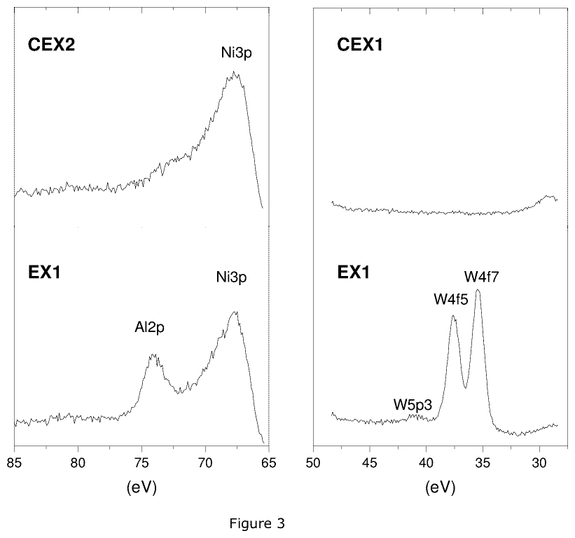

In the Table 4, the XPS analysis results of Al (Ale), W (We), and F (FB) are compared with the ICP results of Al (v), W (w), and F (f). The Ale, We, and Fe higher than 0 indicate that said Al, W, and F present in the surface of the positive electrode active material as associated with the XPS measurement which signal is acquired from the first few nanometers (e.g. 1 nm to 10 nm) of the uppermost part of a sample, i.e. surface layer. On the other hand, v, w, and f from ICP measurement is from the entire particles. Therefore, the ratio of XPS to ICP such as Ale/V, We/w, and Fe/f higher than 1 indicates said elements Al, W, and F presence mostly on the surface of the positive electrode active material. The higher Ale/v, We/w, and Fe/f values correspond with the more Al, W, and F presence in the surface of positive electrode active material. Ale/v in every example except CEX2 are all higher than 50, We/w in every example except CEX1 are all higher than 20, and Fs/f in EX3, EX4, and CEX1 are all higher than 10, which confirm the effectivities of Al, W, and/or F treatment according to this invention. The representative of XPS spectra showing Al₂p, W4f5, and W4f7 peaks of EX1 for comparison with CEX1 or CEX2 are displayed in FIG. 3. In some cases the use of a dopant, eg one or more of the elements B, Ba, Ca, Cr, Fe, Mg,

Mo, Nb, S, Si, Sr, Ti, Y, V, or Zr, can be beneficial for battery characteristics. As is well known to the skilled person such a material may be easily introduced by several methods, eg: Coprecipitation, as in step 1 of examples 1 and 2 or addition of a source of the required elements at the mixing step with a source of Li, as in step 2 of examples 1 and 2, and by many other methods known in the field.

1-17. (canceled)

18. A positive electrode active material for solid-state batteries, wherein the positive electrode active material comprises Li, M′, and oxygen, wherein M′ comprises:
Ni in a content x between 50.0 mol % and 95.0 mol %, relative to M′;
Co in a content y between 0.0 mol % and 40.0 mol %, relative to M′;
Mn in a content z between 0.0 mol % and 70.0 mol %, relative to M′;
Al in a content v between 0.1 mol % and 3.0 mol %;
W in a content w between 0.05 mol % and 2.0 mol %;
F in a content f lower than 2.0 mol %; and
elements other than Li, O, Ni, Co, Mn, Al, W and F in a content q less than 3.0 mol %, relative to M′,
wherein x, y, z, v, w and q are measured by ICP and wherein f is measured by IC;
wherein (x+y+z+v+w+f+q)=100.0 mol %;
wherein the positive electrode active material has ratios Al_{B}/v>25.0 and W_{B}/w>5.0,
wherein Al_{B} and W_{B} are determined by XPS analysis, wherein Al_{B} and W_{B} are expressed as mol % compared to the sum of Ni, Co, Mn, Al, W, and F, as measured by XPS analysis.

19. Positive electrode active material according to claim 18, wherein the ratio Al_{B}/v is higher than 50.0.

20. Positive electrode active material according to claim 18, wherein Mn in a content z between 0.0 mol % and 40.0 mol %, relative to M′.

21. Positive electrode active material according to claim 18, wherein the ratio Al_{B}/v is lower than 250.0 and preferably lower than 200.0.

22. Positive electrode active material according to claim 18, wherein the ratio W_{B}/w is higher than 10.0, preferably higher than 21.0 and more preferably higher than 22.0.

23. Positive electrode active material according to claim 18, wherein the ratio W_{B}/w is lower than 150.0 and preferably lower than 100.0.

24. Positive electrode active material according to claim 18, f>0, wherein the positive electrode active material has ratio F_{B}/f>10.0, wherein F_{B} is determined by XPS analysis, wherein F_{B} is expressed as mol % compared to the sum of Ni, Co, Mn, Al, W, and F, as measured by XPS analysis.

25. Positive electrode active material according to claim 18, wherein said positive electrode active material comprises secondary particles comprising more than one primary particle.

26. Positive electrode active material according to claim 18, wherein said positive electrode active material comprises single-crystalline particles.

27. A positive electrode for lithium-ion rechargeable batteries, comprising a positive electrode active material according to claim 18.

28. A polymer cell for lithium-ion rechargeable batteries, comprising a positive electrode active material according to claim 18.

29. A lithium-ion rechargeable battery comprising a positive electrode active material according to claim 18.

30. A method for manufacturing a positive electrode active material for solid-state batteries, comprising the consecutive steps of
preparing a lithium transition metal-based oxide compound,
mixing said lithium transition metal-based oxide compound with sources of Al and W, thereby obtaining a mixture, and
heating the mixture in an oxidizing atmosphere in a furnace at a temperature between 250° C. and less than 500° C., preferably at most 450° C., for a time between 1 hour and 20 hours so as to obtain said the positive electrode active material powder.

31. Method according to claim 30, wherein said mixing said lithium transition metal-based oxide compound with an additional source of F obtaining the mixture.

32. Method according to claim 30, wherein said positive electrode active material is the positive electrode active material according to any of claims 1 to 9.

33. A method for manufacturing a polymer cell for solid-state lithium-ion rechargeable battery, wherein said method comprises the steps of:
a step of preparing a solid polymer electrolyte film by mixing a first polyethylene oxide having a molecular weight of less than 1,500,000 g/mol and more than 500,000 g/mol with a lithium salt in a nonaqueous solvent;
a step of preparing a positive electrode by mixing a second polyethylene oxide, a lithium salt, a positive electrode active material, and a conductor powder in a nonaqueous solvent, wherein the second polyethylene oxide has a molecular weight of less than 300,000 and more than 50,000g/mol;
a step of preparing a negative electrode comprising a lithium metal; and
a step of assembling the solid polymer electrolyte film, the positive electrode and the negative electrode to form a polymer cell for a solid-state rechargeable battery.

34. A method according to claim 33, wherein the positive electrode active material is a positive electrode active material for solid-state batteries, wherein the positive electrode active material comprises Li, M′, and oxygen, wherein M′ comprises:
Ni in a content x between 50.0 mol % and 95.0 mol %, relative to M′;
Co in a content y between 0.0 mol % and 40.0 mol %, relative to M′;
Mn in a content z between 0.0 mol % and 70.0 mol %, relative to M′;
Al in a content v between 0.1 mol % and 3.0 mol %;
W in a content w between 0.05 mol % and 2.0 mol %;
F in a content f lower than 2.0 mol %; and
elements other than Li, O, Ni, Co, Mn, Al, W and F in a content q less than 3.0 mol %, relative to M′,
wherein x, y, z, v, w and q are measured by ICP and wherein f is measured by IC;
wherein (x+y+z+v+w+f+q)=100.0 mol %;
wherein the positive electrode active material has ratios Al_{B}/v>25.0 and W_{B}/w>5.0,
Al_{B} and W_{B} are determined by XPS analysis, wherein Al_{B} and W_{B} are expressed as mol % compared to the sum of Ni, Co, Mn, Al, W, and F, as measured by XPS analysis.
